(19) United States
(12) Patent Application Publication
(10) Pub. No.: US 2017/0039640 A1
(43) Pub. Date: Feb. 9, 2017

(54) Methods and Systems to Manage a Trading Strategy

(71) Applicant: TRADING TECHNOLOGIES INTERNATIONAL, INC., CHICAGO, IL (US)

(72) Inventors: Scott F. SINGER, Green Oaks, IL (US); William D. CAMPBELL, St. Joseph, IL (US)

(21) Appl. No.: 14/816,782

(22) Filed: Aug. 3, 2015

(51) Int. Cl. G06Q 40/04

(52) U.S. Cl. CPC G06Q 40/04

(57) ABSTRACT

An example method includes receiving a desired strategy price and a definition for a trading strategy including at least three legs. The at least three legs include a first leg associated with a first tradeable object, a second leg associated with a second tradeable object, and a priority leg associated with a third tradeable object. The example method includes communicating a priority order for the priority leg to an exchange and receiving a confirmation of a fill of the priority order. The confirmation identifies a priority price for the fill. The example method includes calculating a first price for a first order of the first leg based on market conditions in the second tradeable object associated with the second leg, the received priority price, and the desired strategy price. The example method includes communicating the first order for the first leg at the calculated first price to the exchange.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

A user may trade multiple tradeable objects according to a trading strategy. For example, spread trading attempts to capitalize on changes or movements in the relationships between the legs of the trading strategy. However, in some instances, one or more legs of a trading strategy may be difficult to fill because of characteristics of the legs(s) and/or market conditions.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a trading strategy, which may be employed with certain disclosed embodiments.

FIG. 5 illustrates a bock diagram of an example system for filling a trading strategy including a priority leg in accordance with the embodiments disclosed herein.

FIGS. 6A and 6B illustrate example priority leg configuration interfaces for defining a priority leg of a trading strategy that may be used to implement the disclosed embodiments.

FIG. 7 illustrates a flowchart representative of example machine readable instructions that may be executed to implement disclosed embodiments.

FIG. 8 is a block diagram representative of an example trading strategy management module that can implement the example machine readable instructions of FIG. 7.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

The disclosed embodiments relate to trading strategies and, more particularly, to methods and systems to manage the individual legs of a trading strategy.

Trading strategies are used to trade more than one tradeable object. A common trading strategy is referred to as a spread. Spreading or spread trading attempts to capitalize on changes or movements in the relationships between the tradeable objects in the trading strategy. Current or known automated trading tools, such as AUTOSPREADER®, provided by Trading Technologies, may be utilized to trade according to a trading strategy, for example. Utilizing an automated trading tool, a trading strategy defining a relationship between two or more tradeable objects to be traded may be configured. Each tradeable object that is traded as part of a trading strategy may be referred to as a leg or outright market of the trading strategy. One or more legs of the trading strategy may be difficult to fill (e.g., match with a contra-side order at the electronic exchange) based on market conditions and/or characteristics of the leg.

The disclosed automated trading tool provides a mechanism by which a difficult to fill leg of a trading strategy can be identified and prioritized as part of the configuration of a trading strategy. A trading strategy configured utilizing the disclosed automated trading tool can capitalize on (i.e., take advantage of) opportunities that may arise to achieve a fill in one or more legs that are typically difficult to fill.

A prioritized leg or priority leg, as identified and/or specified by a trader, identifies to the disclosed automated trading tool the conditions representing a limited opportunity to fill a typically difficult to fill leg under advantageous conditions. When such an opportunity is detected, the trader may want the disclosed automated trading tool to place an order for the priority leg. In particular, the disclosed automated trading tool may place an order at the detected and/or limited opportunity price, rather than at a price calculated originally by the automated trading tool, which is based on available prices in the related legs defined as part of the trading strategy. For example, the disclosed automated trading tool may be configured to place an order for the priority leg at a middle-market price or a price at which there is currently no offer pending and/or indicated for the priority leg. In the example circumstances, the disclosed automated trading tool may be configured to place an order for the priority leg at a middle-market price under the assumption that other legs of the trading strategy can be filled without difficulties.

Examples disclosed herein describe an automated trading tool configured to enable placement of an order for a priority leg based on one or more parameters assigned by the trader. The priority leg is associated with a trading strategy (e.g., a spread). In the disclosed examples, the automated trading tool waits for the priority leg to be filled before implementing trading logic to fill the remaining legs of the trading strategy (e.g., the legs that are not priority legs). For example, after the priority leg is filled, the disclosed automated trading tool proceeds to work to achieve a fill in the quoting leg of the trading strategy. In filling the quoting leg, the automated trading tool can calculate a price for the quoting leg that accounts not only for parameters such as the desired trading strategy price and market conditions associated with tradeable objects of a hedge leg, but also for the price at which the priority leg was filled. After filling the quoting leg, the automated trading tool also fills the hedge legs. Thus, the examples disclosed herein provide for a comprehensive solution to address difficult to fill legs by first filling the priority leg(s) while subsequently taking advantage of the automated trading tool logic to fill the remaining legs.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Certain embodiments provide a method including receiving, by a computing device, a desired strategy price and a definition for a trading strategy including at least three legs. The at least three legs include a first leg associated with a first tradeable object, a second leg associated with a second tradeable object, and a priority leg associated with a third tradeable object. The example method includes communicating, by the computing device, a priority order for the priority leg to an electronic exchange. The example method also includes receiving, by the computing device, a confirmation of a fill of the priority order for the priority leg. The confirmation identifies a priority price for the fill of the priority leg. The example method includes calculating, by the computing device in response to receipt of the confirmation, a first price for a first order to buy or sell the first leg of the trading strategy. The first price is calculated based on market conditions in the second tradeable object associated with the second leg, the received priority price, and the desired strategy price. The example method includes communicating, by the computing device, the first order to buy or sell the first leg of the trading strategy at the calculated first price to the electronic exchange.

Certain embodiments provide a computing device including a processor configured to receive a desired strategy price and a definition for a trading strategy including at least three legs. The at least three legs include a first leg associated with a first tradeable object, a second leg associated with a second tradeable object, and a priority leg associated with a third tradeable object. The example processor is configured to communicate a priority order for the priority leg to an electronic exchange. The example processor is configured to receive a confirmation of a fill of the priority order for the priority leg, wherein the confirmation identifies a priority price for the fill of the priority leg. The example processor is to calculate, in response to receipt of the confirmation, a first price for a first order to buy or sell the first leg of the trading strategy. The first price is calculated based on market conditions in the second tradeable object associated with the second leg, the received priority price, and the desired strategy price. The example processor is to communicate the first order to buy or sell the first leg of the trading strategy at the calculated first price to the electronic exchange.

Certain embodiments provide a tangible computer-readable storage medium comprising instructions that, when executed, cause a machine to at least receive a desired strategy price and a definition for a trading strategy including at least three legs. The at least three legs include a first leg associated with a first tradeable object, a second leg associated with a second tradeable object, and a priority leg associated with a third tradeable object. The instructions cause the machine to communicate a priority order for the priority leg to an electronic exchange. The instructions cause the machine to receive a confirmation of a fill of the priority order for the priority leg, wherein the confirmation identifies a priority price for the fill of the priority leg. The instructions cause the machine to calculate, in response to receipt of the confirmation, a first price for a first order to buy or sell the first leg of the trading strategy. The first price is calculated based on market conditions in the second tradeable object associated with the second leg, the received priority price, and the desired strategy price. The instructions cause the machine to communicate the first order to buy or sell the first leg of the trading strategy at the calculated first price to the electronic exchange.

### II. Example Electronic Trading System

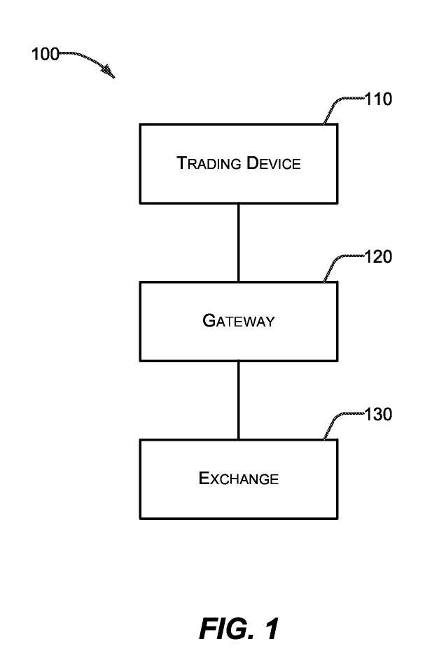

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device maybe executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

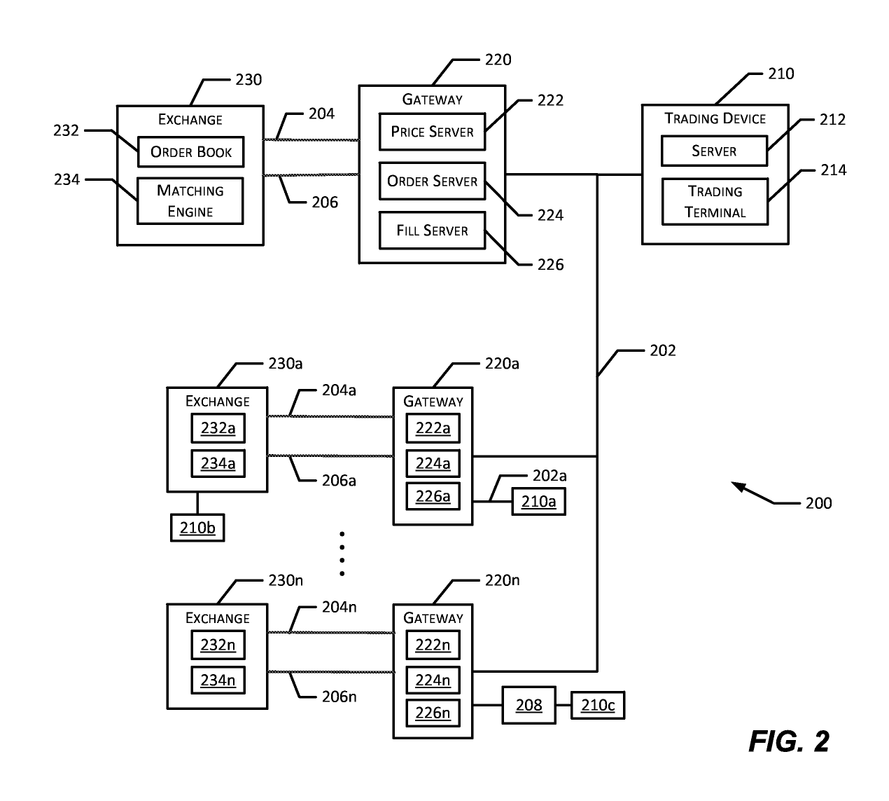

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

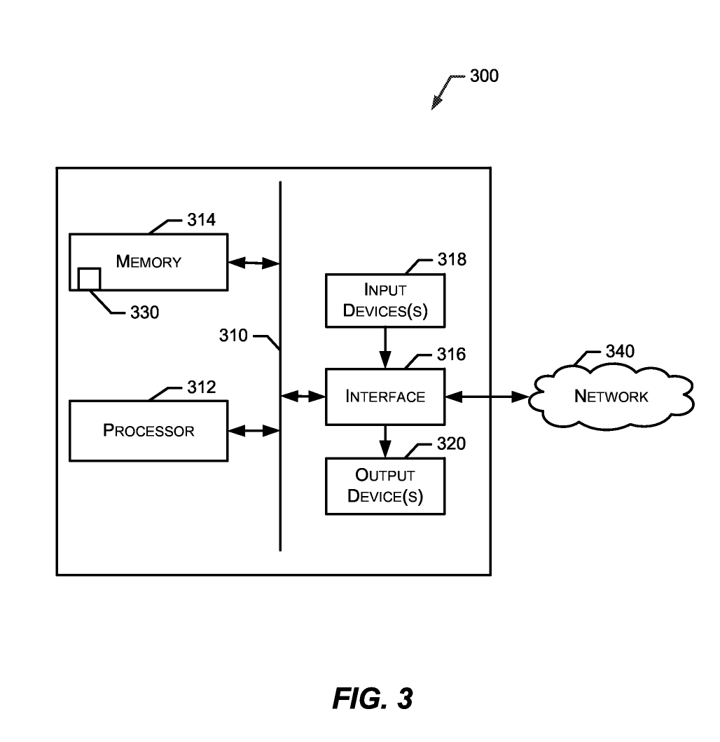

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Strategy Trading

In addition to buying and/or selling a single tradeable object, a user may trade more than one tradeable object according to a trading strategy. One common trading strategy is a spread and trading according to a trading strategy may also be referred to as spread trading. Spread trading may attempt to capitalize on changes or movements in the relationships between the tradeable object in the trading strategy, for example.

An automated trading tool may be utilized to trade according to a trading strategy, for example. For example, the automated trading tool may include AUTOSPREADER®, provided by Trading Technologies.

A trading strategy defines a relationship between two or more tradeable objects to be traded. Each tradeable object being traded as part of a trading strategy may be referred to as a leg or outright market of the trading strategy.

When the trading strategy is to be bought, the definition for the trading strategy specifies which tradeable object corresponding to each leg should be bought or sold. Similarly, when the trading strategy is to be sold, the definition specifies which tradeable objects corresponding to each leg should be bought or sold. For example, a trading strategy may be defined such that buying the trading strategy involves buying one unit of a first tradeable object for leg A and selling one unit of a second tradeable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradeable object for leg A and selling 3 units of a second tradeable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “4.”

In addition, the spread ratio for each leg may be collectively referred to as the spread ratio or strategy ratio for the trading strategy. For example, if leg A has a spread ratio of “2” and leg B has a spread ratio of “−3”, the spread ratio (or strategy ratio) for the trading strategy may be expressed as “2:−3” or as “2:3” if the sign for leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

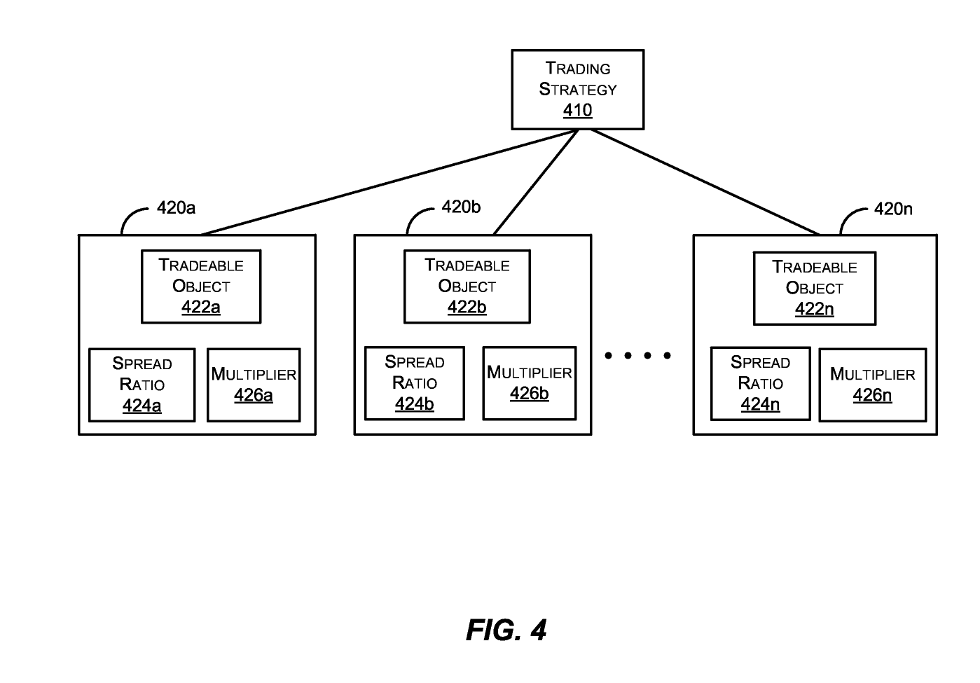

FIG. 4 illustrates a block diagram of a trading strategy 410 which may be employed with certain disclosed embodiments. The trading strategy 410 includes “n” legs 420 (individually identified as leg 420a to leg 420n). The trading strategy 410 defines the relationship between tradeable objects 422 (individually identified as tradeable object 422a to tradeable object 422n) of each of the legs 420a to 420n using the corresponding spread ratios 424a to 424n and multipliers 426a to 426n.

Once defined, the tradeable objects 422 in the trading strategy 410 may then be traded together according to the defined relationship. For example, assume that the trading strategy 410 is a spread with two legs, leg 420a and leg 420b. Leg 420a is for tradeable object 422a and leg 420b is for tradeable object 422b. In addition, assume that the spread ratio 424a and multiplier 426a associated with leg 420a are “1” and that the spread ratio 424b and multiplier 426b associated with leg 420b are “−1”. That is, the spread is defined such that when the spread is bought, 1 unit of tradeable object 422a is bought (positive spread ratio, same direction as the spread) and 1 unit of tradeable object 422b is sold (negative spread ratio, opposite direction of the spread). As mentioned above, typically in spread trading the opposite of the definition applies. That is, when the definition for the spread is such that when the spread is sold, 1 unit of tradeable object 422a is sold (positive spread ratio, same direction as the spread) and 1 unit of tradeable object 422b is bought (negative spread ratio, opposite direction of the spread).

The price for the trading strategy 410 is determined based on the definition. In particular, the price for the trading strategy 410 is typically the sum of price the legs 420a-420n including the tradeable objects 422a-422n multiplied by corresponding multipliers 426a-426n. The price for a trading strategy may be affected by price tick rounding and/or pay-up ticks. However, both of these implementation details are beyond the scope of this discussion and are well-known in the art.

Recall that, as discussed above, a real spread may be listed at an exchange, such as exchange 130 and/or 230, as a tradeable product. In contrast, a synthetic spread may not be listed as a product at an exchange, but rather the various legs of the spread are tradeable at one or more exchanges. For the purposes of the following example, the trading strategy 410 described is a synthetic trading strategy. However, similar techniques to those described below may also be applied by an exchange when a real trading strategy is traded.

Continuing the example from above, if it is expected or believed that tradeable object 422a typically has a price 10 greater than tradeable object 422b, then it may be advantageous to buy the spread whenever the difference in price between tradeable objects 422a and 422b is less than 10 and sell the spread whenever the difference is greater than 10. As an example, assume that tradeable object 422a is at a price of 45 and tradeable object 422b is at a price of 40. The current spread price may then be determined to be (1)(45)+(−1)(40)=5, which is less than the typical spread of 10. Thus, a user may buy 1 unit of the spread, which results in buying 1 unit of tradeable object 422a at a price of 45 and selling 1 unit of tradeable object 422b at 40. At some later time, the typical price difference may be restored and the price of tradeable object 422a is 42 and the price of tradeable object 422b is 32. At this point, the price of the spread is now 10. If the user sells 1 unit of the spread to close out the user's position (that is, sells 1 unit of tradeable object 422a and buys 1 unit of tradeable object 422b), the user has made a profit on the total transaction. In particular, while the user bought tradeable object 422a at a price of 45 and sold at 42, losing 3, the user sold tradeable object 422b at a price of 40 and bought at 32, for a profit of 8. Thus, the user made 5 on the buying and selling of the spread.

The above example assumes that there is sufficient liquidity and stability that the tradeable objects can be bought and sold at the market price at approximately the desired times. This allows the desired price for the spread to be achieved. However, more generally, a desired price at which to buy or sell a particular trading strategy is determined. Then, an automated trading tool, for example, attempts to achieve that desired price by buying and selling the legs at appropriate prices. For example, when a user instructs the trading tool to buy or sell the trading strategy 410 at a desired price, the automated trading tool may automatically place an order (also referred to as quoting an order) for one of the tradeable objects 422 of the trading strategy 410 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order could be filled at in the lean leg. The target price in the hedge leg is also known as the leaned on price, lean price, and/or lean level. Typically, if there is sufficient quantity available, the target price may be the best bid price when selling and the best ask price when buying. The target price may be different than the best price available if there is not enough quantity available at that price or because it is an implied price, for example. As the leaned on price changes, the price for the order in the quoting leg may also change to maintain the desired strategy price.

The leaned on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available. The lean multiplier and lean base may also be used in combination. For example, the lean base and lean multiplier may be utilized such that larger of the two is used or they may be used additively to determine the amount of quantity to be available.

When the quoting leg is filled, the automated trading tool may then submit an order in the hedge leg to complete the strategy. This order may be referred to as an offsetting or hedging order. The offsetting order may be placed at the leaned on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized.

### VI. Methods and Systems to Manage Legs of Trading Strategy

Example methods and systems to manage legs of a trading strategy are disclosed herein. In particular, the disclosed automated trading tool manages the legs of a trading strategy when one or more legs are difficult to fill based on market conditions and/or characteristics of the leg.

As discussed above in connection with FIG. 4, two or more tradeable objects such as individual contracts or exchange traded spreads can be traded according to a trading strategy. For example, the pricing of the individual legs of the trading strategy are interrelated such that a fill in a first leg of the trading strategy at a first price can influence a trading approach taken with respect to filling a second leg (or subsequent legs) of the trading strategy. Thus, when a trading strategy includes a leg is that is difficult to fill based on market conditions and/or characteristics of the leg, the pricing of the other (i.e. remaining) legs of the trading strategy can be affected in view of the relationship defined as part of the strategy. The difficult to fill leg can be identified or otherwise designated as a priority leg. Designation or identification of one of the legs of a trading strategy as a priority leg indicates to the disclosed automated trading tool that an opportunity exists to achieve a fill in one or more legs that are typically difficult to fill.

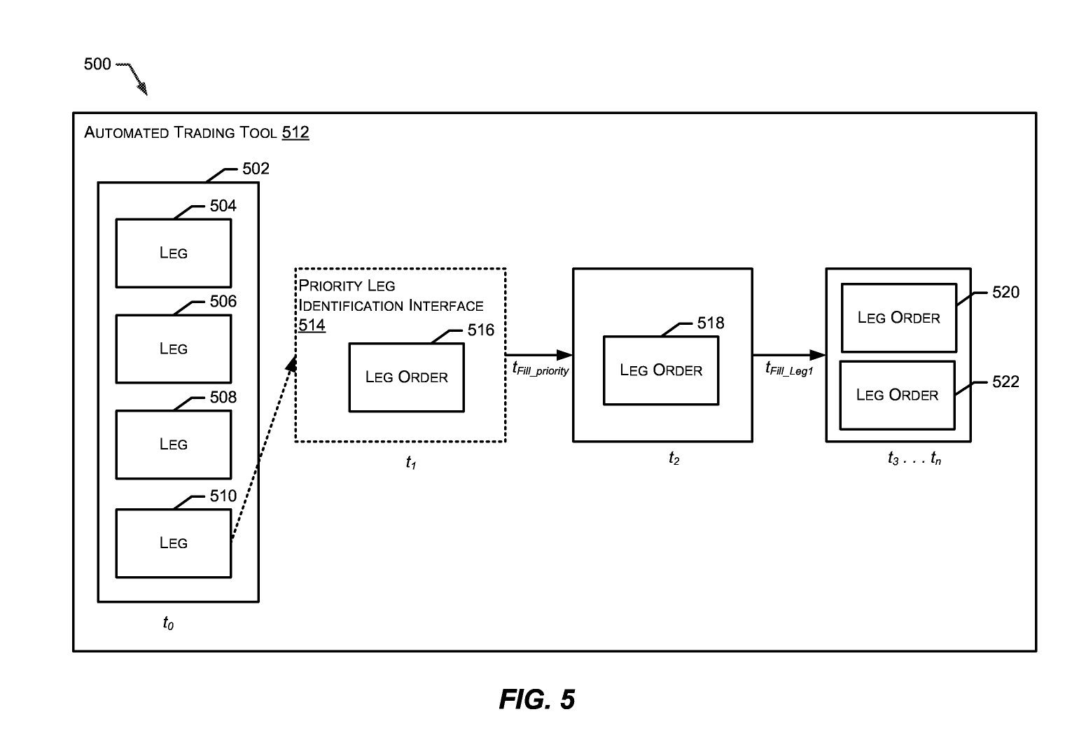

FIG. 5 is a block diagram of an example system 500 for implementing a trading strategy that specifies or defines a plurality of legs and further identifies one leg as the priority leg. In operation, the priority leg is a leg of a trading strategy that has been prioritized for filling before the remaining legs are subsequently filled by the automated trading tool.

The system 500 depicts an example trading strategy 502 that includes multiple legs 504, 506, 508 and 510. The example trading strategy 502 is depicted at time t₀. The time t₀ corresponds to the creation and/or definition of the trading strategy 502. Each of the legs is associated with one or more tradeable objects such as an exchange traded spread. The trading strategy 502 includes and specifies a desired trading strategy price. An automated trading tool 512 manages and/or monitors the trading strategy 502. The system 500 illustrates that at time t₀, the automated trading tool 512 is managing the trading strategy 502 as it works (e.g., is in-process) at the trading strategy server and/or the electronic exchange.

The automated trading tool 512 manages the example trading strategy 502 including the leg 510. In the illustrated example, the leg 510 is designated and/or identified as the priority leg based on one or more conditions, characteristics, and/or parameters that result in the leg being difficult to fill (e.g., match quantity of the order with quantity of one or more contra-side orders). For example, factors such as the price at which the tradeable object is trading, and/or the liquidity of the market can render a fill in the priority leg (e.g., the leg 510) difficult to achieve. Other factors can be established and/or defined as actionable rules and thresholds according to individual preferences. In some examples, the characteristics of the leg 510 and/or market conditions result in uncertainty as to whether the leg 510 will be filled. Conversely, there may be little uncertainty about filling the remaining legs 504, 506, 508.

In an attempt to address the uncertainty associated with the filling of leg 510 (i.e., the priority leg in the present example), the disclosed automated trading tool 512 may be configured to include one or more instructions and/or adjustments that specify the handling of the leg 510 with respect to the remaining legs of the trading strategy 502. For example, the automated trading tool 512 may hold or otherwise wait to fill the individual orders associated with legs 504, 506, 508 until leg 510 is filled. By way of contrast, current automated trading tools may be able to fill legs 504, 506, and 508 but then be unable to complete the trading strategy due to market conditions in the market for leg 510.

To address the limitations of current automated trading tools, the disclosed automated trading tool 512 can be configured to prioritize the leg 510 with respect to the remaining legs 504, 506 and 508 defined as part of the trading strategy 502. In other words, the leg 510 is classified, flagged, or more generally identified as a priority leg to the disclosed automated trading tool 512 resulting in an order for the priority leg being worked in the market before orders for the remaining legs 504, 506 and 508 are sent to the exchange to be worked according to the trading strategy. Such an arrangement prioritizes the filling of leg 510 in view of the uncertainty regarding leg 510. In particular, when leg 510 is identified as a priority leg, legs 504, 506, and 508 are not sent to the market to be filled until leg 510 is filled (e.g., until a fill confirmation is received).

FIG. 5 further illustrates the trading strategy 502 at times t₁ to t₃ . . . tₙ, where these time periods are subsequent to time t₀. The activities occurring at times t₁ to t₃ depict the actions taken by the automated trading tool 512 as it works the priority leg (i.e., leg 510 in the present example) separately from legs 504, 506, and 508. In particular, at time t₁ the leg 510 is identified as a priority leg utilizing a priority leg identification interface 514. The priority leg identification interface 514 can be associated with the automated trading tool 512. Identification of the leg 510 as a priority leg via the priority leg identification interface 514 alters the treatment of the trading strategy 502 by the disclosed automated trading tool 512. In other examples the priority leg may be defined by another system component, such as another trading strategy, or remotely by another user such as a senior trader, a risk administrator, and a trade broker.

Once the priority leg and/or the priority leg(s) of trading strategy 502 has been identified to the automated trading tool 512, a priority order 516 for the leg 510 may be generated and transmitted to the exchange to work. In operation, the automated trading tool 512 waits for fill confirmation of the order associated with the priority leg, or full selection of existing fills for a priority leg, before submitting any quote or hedge orders for the remaining legs 504, 506, and 508 defined as a part of the trading strategy 502. Thus, upon determination that the priority order 516 has been filled, the automated trading tool 512 sends (or releases if the orders had been held) orders for the legs 504, 506, and 508 specified as part of the trading strategy 502. In operation, the orders sent to the exchange (e.g., orders associated with legs 504, 506, and 508) may be created or generated before transmission, may be stored and/or queued awaiting transmission to the exchange, and/or may be stored at the exchange in a pending or held state. In certain embodiments, the disclosed automated trading tool 512 may be working orders for legs 504, 506, and/or 508 in the market prior to the identification of the leg 510 as the priority leg. Once the priority leg has been designated, the disclosed automated trading tool 512 may, for example, cancel all working orders for legs 504, 506, and/or 508, may direct the working orders to be changed to a held state, may modify the working orders in an attempt to prevent an unwanted fill, or may modify all working orders for legs 504, 506, and/or 508 to cross the market. For example, the disclosed automated trading tool 512 may modify the desired price of one or more working order to a price away from the inside market.

In certain embodiments, the automated trading tool 512 monitors the priority order 516 associated with the leg 510 while it works at the exchange. The automated trading tool 512 receives a fill confirmation generated at the exchange when the priority order 516 is filled at time t_{fill}_{_}_{priority}. The fill confirmation associated with the priority order 516 includes a price (e.g., a “priority price”) at which the priority orders was filled.

Upon receiving the confirmation of the fill of the priority order 516 for the leg 510 at time t_{fill}_{_}_{priority}, the automated trading tool 512 communicates one or more orders associated with legs 504, 506, and 508 according to the trading strategy 502. As shown in FIG. 5, at time t₂ the automated trading tool 512 communicates an order 518 to buy or sell a tradeable object associated with leg of trading strategy 502. The automated trading tool 512 calculates the price for the order 518 based on (1) the priority price achieved in the fill of the priority order 516 associated with leg 510, (2) the market conditions for the tradeable object associated with the leg 506 and/or the tradeable object associated with the leg 508, and (3) the desired price for the trading strategy 502.

Similarly, at time t_{fill}_{_}_{Leg1}, the automated trading tool 512 receives a fill confirmation of the order 518 for the leg 504. In response to the received fill confirmation, the automated trading tool 512 communicates the remaining orders 518 and 520 associated with legs 506 and 508 according to the trading strategy 502. As shown in FIG. 5, at time t₃ . . . tₙ the automated trading tool 512 communicates order 520 to buy or sell a tradeable object associated with leg 506 of trading strategy 502 and order 522 to buy or sell a tradeable object associated with leg 508 of trading strategy 502. The automated trading tool 512 may automatically work the orders 518, 520, and 522 according to the disclosure of U.S. Pat. No. 7,437,325, the content of which is incorporated herein by reference for all purposes. In this way, if an advantageous price is obtained for the priority order 516 for the leg 510, the automated trading tool 512 may quote the order 518 for the leg 504 at a more aggressive price (e.g., a lower price for selling or a higher price for buying) in view of the priority price achieved in connection with the leg 510 and in view of the market conditions for the and/or legs 506, 508, and the desired trading strategy price.

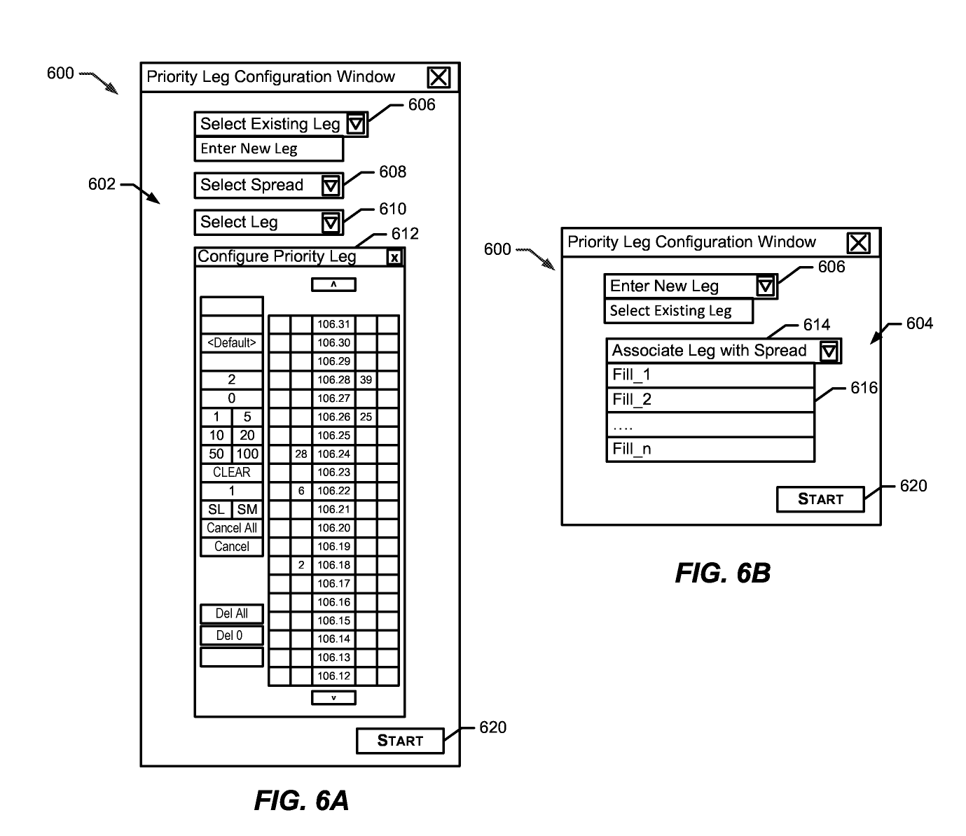

FIG. 6A depicts one example of a graphical user interface 600 that may represent the priority leg identification interface 514. The example graphical user interface 600 can be used to configure the leg 510 as a priority leg. The example graphical user interface 600 may be generated by the disclosed automated trading tool 512. In certain embodiments, the example graphical user interface 600 may be an interface and/or webpage accessed by the disclosed automated trading tool 512. Utilizing the example graphical user interface 600, one or more legs can be designated as a priority leg(s). The interface 600 of FIG. 6 can be accessed by a trader via a trading device and can be associated with the automated trading tool 512 of FIG. 5.

The graphical user interface 600 includes first interface section 602 and a second interface section 604. In certain embodiments, the first interface section 602 and the second interface section 604 may be displayed together as part of the graphical user interface 600. In other embodiments, the first interface section 602 may be displayed independently from the second interface section 604. The first interface section 602 may be utilized to identify and/or designate one or more legs of a trading strategy as priority legs. The second interface section 604 may be utilized to identify and/or designate a new leg as a priority leg. Selection of the first interface section 602 or the second interface section 604 may be accomplished via, for example, a dropdown menu box such as the first menu 606. As shown in FIG. 6A, designation of an existing leg may be accomplished by choosing the “select existing leg” option in the first menu 606. Selection of the “select existing leg” option in the first menu 606 results in the graphical user interface 600 shown in FIG. 6A being displayed. Similarly, as shown in FIG. 6B, designation of a new leg may be accomplished by choosing the “enter new leg” option in the first menu 606. Selection of the “enter new leg” option in the first menu 606 results in the graphical user interface 600 shown in FIG. 6B being displayed.

The first interface section 602 may be utilized to designate an existing leg (e.g., the leg 510 defined as part of the trading strategy 502) as the priority leg. In particular, the spread menu 608 may be utilized to identify and select a trading strategy that includes the leg of interest. The trading strategy displayed in the spread menu 608 may be the trading strategy 502 including the leg 510. The trading strategy can be, for example, a spread. The first interface section 602 may further include a leg menu 610. The leg menu 610 provides a list of the spread legs associated with the trading strategy identified and/or selected in spread menu 608. For example, the trading strategy 502 may be identified and/or selected in the spread menu 608, and a specific leg of the trading strategy 502 may be identified and/or selected in the leg menu 610. Identification of the trading strategy and the existing leg can be based on an identifier such as a name, a label, a tag, etc., used to identify the trading strategy and the leg. Upon selection of the trading strategy and the leg, the interface 600 displays a configuration menu 612 listing the parameters associated with an order(s) for the selected leg(s) (e.g., price levels, buy and ask quantities, etc.). The parameters associated with the designated priority leg may be modified via the configuration menu 612. Example modifications can include adjustments to buy or ask prices and/or quantities in an effort to generate an offer for an order for the leg 510.

The first interface section 602 provides a mechanism by which a trader or other user may flag a leg as a priority leg after the trading strategy has been defined for the automated trading tool 512. In some examples, the first interface section 602 may be used to flag a leg as a priority leg after orders for filling the legs of the trading strategy have been submitted to the exchange by the automated trading tool 512. Identification of the priority leg(s) may be based on, for example, a duration of time that the problem leg(s) (e.g., the leg 510) is at the exchange without having an order filled, the number of price levels that the order is away from the inside market (either bid side, ask side or midpoint), how much quantity has traded at the exchange while the order has been pending, and the amount of time left in the trading session. Other criteria that may be used to identify a priority could be based on, for example, the number of ticks the order is away from the inside market, how much (or little) quantity has traded since the order was placed (by tracking TTQ), and/or an amount of time left in the trading session.

The second interface section 604 may be utilized to prioritize an order for a leg after that order has been filled at, for example, an unexpected price. The existing order can be, for example, an order for the leg 510 previously submitted to the exchange by the automated trading tool 512 as part of completing the trading strategy 502.

For example, the example second interface 604 provides a selection dropdown such as an association menu 614 that lists or includes identifiers for trading strategies available (e.g., accessible via permissions) to be associated with the selected order. Selection or identification of a trading strategy in the associate menu 614 generates a list of filled order (e.g., fills) depicted in the interface item 616. In other examples, a previously filled order may be selected from an order or fill repository, such as via the fill window in X_TRADER®, identified as a priority leg, and associated with a previously defined trading strategy. Such as an association may be desirable based on the relationship of the previously existing fill(s) to the current market, which when taken as the fill(s) for the trading strategy can positively affect the prices required by the trading strategy for quoting or hedging orders the non-priority legs of trading strategy 502. For example, in view of the advantageous price of the fill associated with priority leg 510, a more aggressive price may be used when submitting the subsequent quoting orders for one or more of legs 504, 506, or 508 while still achieving the desired price for the trading strategy 502. Thus, it may be beneficial to associate a previously obtained fill with the priority leg(s) of the trading strategy.

In certain embodiments, the trading strategy may be defined without indicating which legs are priority legs while still indicating that trading strategy 502 will include priority legs. In this example the priority legs of the spread will be determined by tracking in which spread legs the orders are subsequently placed. In this example the trader will create the trading strategy with a priority indication, causing automated trading tool 512 to monitor orders and related fills for association with the trading strategy. In this example the trader may define orders for tradable objects that make up the legs of the trading strategy tagged with the unique priority identifier of the trading strategy 502 so that they may be identified by automated trading tool 512 as being part of trading strategy 502. The example interface 600 includes an activation button 620 that, in response to a user selection, communicates to automated trading tool 512 that no additional orders will be created or placed. The automated trading tool 512, in turn, groups or otherwise associates the legs for which orders have been placed with the priority leg(s) for trading strategy 502.

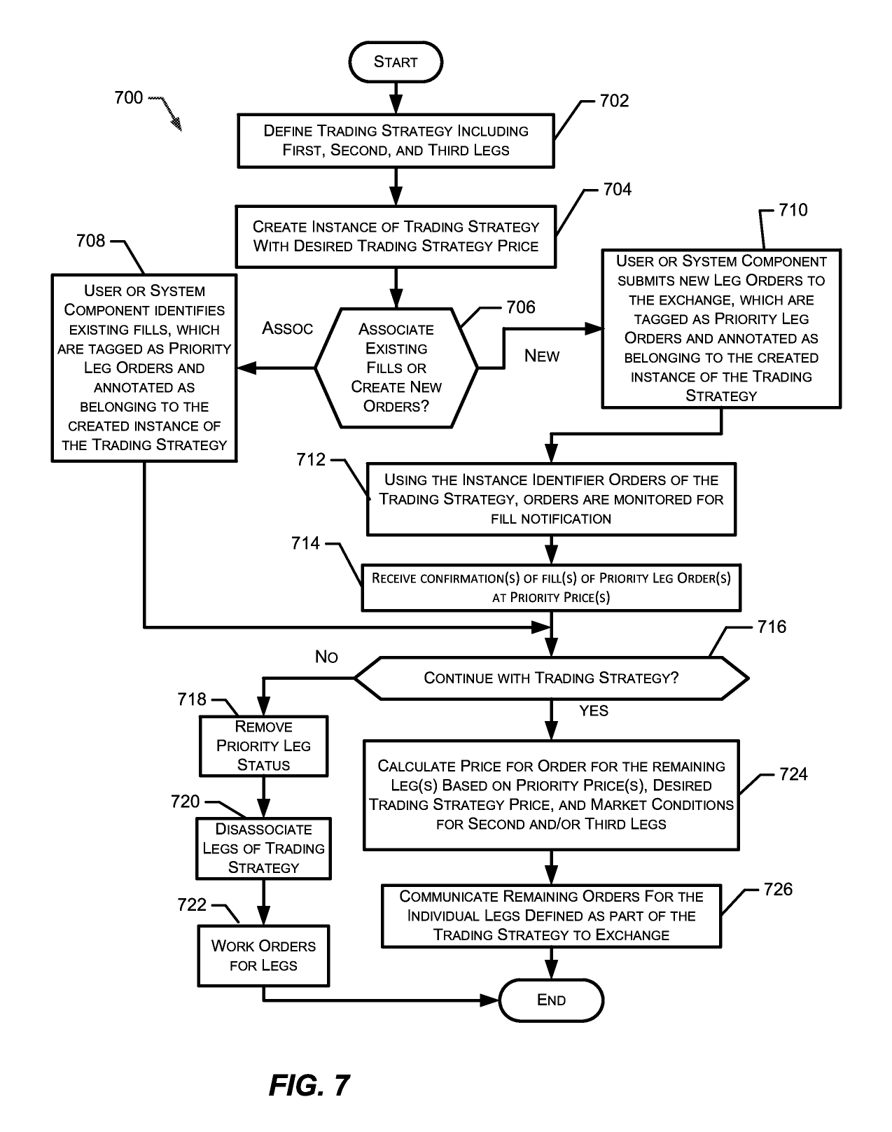

FIG. 7 is a flowchart of an example method 700 for managing a trading strategy including one or more priority legs. The example method 700 includes defining a trading strategy including two or more legs and a desired price for the trading strategy (block 702). The definition of the trading strategy can be created and/or received by an automated trading tool (e.g., the automated trading tool 512 of FIG. 5). The trading strategy of the example method 700 includes a first leg associated with a first tradeable object, a second leg associated with a second tradeable object, and a third leg associated with a third tradeable object. The desired trading strategy price can be based on one or more factors, such as market conditions, types and quantities of available tradeable objects in each leg of the trading strategy that are expected and/or desired to be bought or sold. In some examples, the trading strategy of the method 700 is a spread, such that a relationship exists between filling two or more legs of the trading strategy with respect to pricing of the orders.

The example method 700 utilizes the strategy definition that describes the relationship between the first, second and third legs to create an instance of the trading strategy that may be worked at one or more exchange (block 704). For example, the automated trading tool utilizes the strategy definition including the desired strategy price to generate one or more orders for communication to an exchange(s) to be filled according to the defined trading strategy.

The example method 700 includes the option to create a new order including a priority leg, or associate an existing order and fill as a priority leg to the trading strategy (block 706). For example, the automated trading tool 512 may be configured via the priority leg identification interface 514. If an existing order and fill is to be associated with a current instance of the trading strategy, the example method 700 proceeds to block 708. At block 708, the method 700 updates the trading strategy to include the priority leg identified as the existing order and fill. In other words, an order for a tradeable object can be added to and/or associated with a previously defined trading strategy. Once the existing order has been identified and associated with the trading strategy, the method proceeds to block 716. However, if a new order is to be created and designated as a priority order, the method proceeds to block 710. At block 710, the method 700 may communicate the new leg orders to the exchange as a priority order. The communicated priority order may be flagged and/or annotated to indicate that it is associated with the trading strategy.

The example method 700 utilizes the flag or other instance identifier associated with the trading strategy to monitor the orders and order fills for the individual legs of the trading strategy (block 712). For example, the automated trading tool submits one or more orders (e.g., buy orders or sell orders) for the first, second, and third legs of the trading strategy to an electronic exchange. The automated trading tool also monitors for offers and/or fills to complete the orders.

The example method 700 includes receiving, by the automated trading tool, fill confirmations for one or more orders related to priority legs (block 714). Identification and/or receipt of a fill confirmation related to the priority leg may be utilized by the disclosed automated trading tool to direct the actions or timing of the trading strategy.

The example method 700 includes a determination of whether the in-progress trading strategy should continue (block 716) once a fill confirmation has been received and/or identified in connection with the order for the designated priority leg. If the trader decides to cancel the in-progress trading strategy, the automated trading tool removes the priority leg status or identification from the leg(s) designated as such (block 718). Thus, the legs are no longer designated as priority legs but are considered “normal” legs. The legs of the trading strategy, including the previously identified priority legs are, in turn, disassociated from the trading strategy (block 720). As a result of the cancellation of the trading strategy, the individual orders for each of the legs, including the previously identified priority legs, may remain working in the market or may be cancelled/deleted based on spread configuration or user preference.

If the trader decides to continue with the trading strategy after receiving a fill confirmation in connection with the priority leg, the example method 700 includes calculating a price for an order for the remaining leg(s) of the trading strategy (block 724). Rather than quoting the first order at, for example, a market price, the automated trading tool uses the priority price(s) in combination with the desired trading strategy price when calculating the price for the order of the first leg. Additionally, the automated trading tool considers market conditions for the tradeable objects associated with the other legs of the trading strategy (e.g., the second or third legs) in calculating the price for the order for the first leg. For example, the automated trading tool can calculate the price for the first order based on a price (e.g., a best price or an expected price) that can be obtained for the orders of the second and/or third legs of the trading strategy.

Thus, in view of the fill of the priority leg order(s) the automated trading tool dynamically adjusts the price quote for the order of the first leg (and any other non-priority quoting legs) while also accounting for other parameters or market conditions that affect filling the order for the first leg and/or the trading strategy. In some examples, the price quoted for the order of the first leg may be less favorable relative to a market price for the first leg without detriment to the desired trading strategy price. Such dynamic adjustments provide for flexibility in quoting the first order based on a variety of factors including the priority price and other market conditions to obtain the desired trading strategy price.

After calculating the price for the order of the first leg, the automated trading tool submits or communicates the order for the remaining legs of the trading strategy to the electronic exchange (block 726). The remaining legs of the trading strategy may be automatically worked according to, for example, the disclosure of U.S. Pat. No. 7,437,325, the content of which is incorporated herein by reference for all purposes. The prices for the orders for the second and/or third legs can be based on one or more of the prices obtained for the priority leg(s) and/or the first leg, market conditions, etc. In some examples, a better-expected-fill for the first leg results in the second leg and/or the third leg crossing-the-market, or accepting an offer at a less favorable price if the less favorable price does not prevent the desired trading strategy price from being obtained. When orders for the legs are filled, the example method 700 ends.

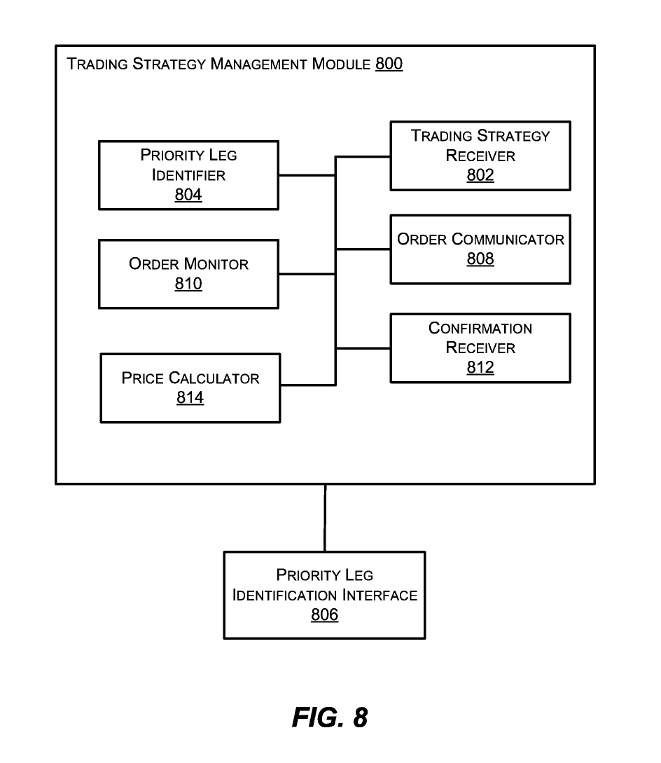

FIG. 8 is a block diagram of an example trading strategy management module 800 that may implement and/or execute the example operations of FIG. 7. In some examples, the module 800 may be implemented as part of software (or an application) associated with the trading device 110, the gateway 120 of FIG. 1, and/or the automated trading tool 512 of FIG. 5. In some examples, the management module 800 may be implemented as computer implemented code or instructions operable independent of software associated with the trading device 110, the gateway 120, and/or the automated trading tool 512. In some examples, the features and functionality of the management module 800 may be implemented in hardware operable in connection with the trading device 110 and/or the gateway 120 of FIG. 1 of the automated trading tool 512 of FIG. 5. Also, in some examples, the management module 800 is implemented and/or is associated with the trading strategy 410 of FIG. 4 (e.g., spread trading).

The example trading strategy management module 800 includes a trading strategy receiver 802. The trading strategy receiver 802 receives a definition for a trading strategy (e.g., the trading strategy 502 of FIG. 5). A trading strategy definition specifies two or more legs (e.g., a quoting leg and a hedge leg of a spread). The trading strategy receiver 802 also receives a desired price for the trading strategy. The trading strategy definition and the desired price can be input by a user via, for example, the trading device 110.

The example trading strategy management module 800 includes a priority leg identifier 804. The priority leg identifier 804 can be implemented in connection with a priority leg identification interface 806 (e.g., the example interface 600 of FIG. 6). The priority leg identification interface 806 enables a trader to input one or more selections, values, etc. that are used by the priority leg identifier 804 to identify an existing leg of a trading strategy as a priority leg or to receive information related to a new priority leg not previously associated with a trading strategy received by the trading strategy receiver 802. Values input by the trader via the priority leg identification interface 806 can relate to, for example, quantity and value information (e.g., prices, working range, tick information, timing conditions) for the tradeable object(s) associated with the priority leg. The priority leg identifier 804 associates a tag and/or associates the priority leg with the trading strategy so that, for example, the automated trading tool 512 refrains from working orders associated with the remaining legs of the trading strategy until a fill confirmation for the priority leg(s) has been received. The automated trading tool 512 may further utilize the tag to prevent working the remaining legs of a trading strategy while an associated priority leg is identified as being hung and/or unfulfilled.

An order communicator 808 of the example trading strategy management module 800 submits or communicates orders to an electronic exchange. For example, the order communicator 808 submits priority leg order(s) to the exchange based on information received via the priority leg identification interface 806. The order communicator 808 may be further configured to submit orders for the remaining, non-priority legs of the trading strategy.

An order monitor 810 monitors the trading activity of the orders submitted to the exchange by the order communicator 808. The order monitor 810 can monitor the priority leg order(s) to determine whether the priority leg(s) have been filled. Also, after filling of the priority leg order(s), the order monitor 801 can monitor the filling of the orders for the other, non-priority legs of the trading strategy. Based on the monitoring by the order monitor 810, the order communicator may submit one or more orders for the legs to the exchange. For example, if the order monitor 808 detects that an order for a non-priority quoting leg (e.g., the first order 518 of FIG. 5) has been filled, the order communicator 808 submits an order for a non-priority hedge leg (e.g., second or third orders 520, 522 of FIG. 5).

The example trading strategy management module 800 also includes a confirmation receiver 812. The confirmation receiver 812 receives confirmation(s) from, for example, the exchange, that the priority leg order(s) have been filled. The confirmation receiver 812 also receives a price at which a priority leg order was filled. The confirmation receiver 812 can also receive confirmation(s) that one or more of the non-priority legs of the trading strategy have been filled at the exchange and associated order prices. In response to receiving the confirmation(s) of the fill(s), the confirmation receiver 812 can direct, for example, order communicator 808 to submit one or more orders for the legs of the trading strategy. For example, after receiving confirmation that a priority leg order has been filled, the confirmation receiver 812 can instruct the order communicator to submit orders for the non-priority legs.

The example trading strategy management module 800 includes a price calculator 814. Upon receiving the confirmation of the filling of a priority leg order and the priority price at which the leg was filled, the confirmation receiver 812 provides the priority price information to the price calculator 814. The price calculator 812 calculates prices for one or more orders for the non-priority legs (e.g., the first order 518) of the trading strategy using, for example, the priority price, the desired trading strategy price, and market conditions related to other legs of the trading strategy. The price calculator 814 provides the calculated price to the order communicator 808 for submission in connection with the order to the exchange. The price calculator 814 can also calculate prices for orders for the hedge legs of the trading strategy (e.g., the second or third orders 520, 522). In some examples, the price calculator 814 evaluates whether, for example, a leg should cross-the-market and accept an offer at less favorable price in view of the prices obtained for the previously orders (e.g., the priority order 516, the first order 518) and the desired trading strategy price.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
receiving, by a computing device, a desired strategy price and a definition for a trading strategy including at least three legs, wherein the at least three legs include a first leg associated with a first tradeable object, a second leg associated with a second tradeable object, and a priority leg associated with a third tradeable object;
communicating, by the computing device, a priority order for the priority leg to an electronic exchange;
receiving, by the computing device, a confirmation of a fill of the priority order for the priority leg, wherein the confirmation identifies a priority price for the fill of the priority leg;
calculating, by the computing device in response to receipt of the confirmation, a first price for a first order to buy or sell the first leg of the trading strategy, wherein the first price is calculated based on market conditions in the second tradeable object associated with the second leg, the received priority price, and the desired strategy price; and
communicating, by the computing device, the first order to buy or sell the first leg of the trading strategy at the calculated first price to the electronic exchange.

2. The method of claim 1, further comprising:
receiving a second confirmation of a fill of a second order for a fourth leg of the trading strategy, wherein the fourth leg is associated with the third tradeable object; and
identifying the fourth leg as the priority leg based on the confirmation of the fill of the second order.

3. The method of claim 1, further comprising:
monitoring, by the computing device, the trading strategy;
identifying, by the computing device, the priority leg associated with the trading strategy; and
upon the identification of the priority leg, automatically refraining from filling a remainder of the at least three legs until receipt of the confirmation of the fill of the priority order for the priority leg.

4. The method of claim 3, wherein the priority leg is identified based on one or more of a quantity of the order for the priority leg, a price for the order of the priority leg, a liquidity of the priority leg, a duration of time for which the priority leg is at the electronic exchange, or a condition at the electronic exchange.

5. The method of claim 1, further comprising:
identifying, by the computing device, at least one of the three legs of the trading strategy as the priority leg after receiving the trading strategy; and
monitoring for the fill of the priority order of the priority leg based on the identification of the priority leg in the trading strategy.

6. The method of claim 1, further comprising:
receiving, by the computing device, the priority leg;
associating the priority leg with the trading strategy; and
monitoring for the fill of the priority order of the priority leg based on the association of the priority leg with the trading strategy.

7. The method of claim 1, further comprising communicating, by the computing device upon the filling of the first order to buy or sell the first leg at the first price, a trade action to the electronic exchange to fill a second order for the second leg.

8. The method of claim 1, further comprising, if the trading strategy is cancelled prior to receiving the confirmation of the fill of the priority order for the priority leg,
disassociating the at least three legs of the trading strategy; and
removing an identification of the priority leg; and
working the at least three legs at the electronic exchange to fill orders for the at least three legs.

9. A system comprising a computing device including a processor configured to:
receive a desired strategy price and a definition for a trading strategy including at least three legs, wherein the at least three legs include a first leg associated with a first tradeable object, a second leg associated with a second tradeable object, and a priority leg associated with a third tradeable object;
communicate a priority order for the priority leg to an electronic exchange;
receive a confirmation of a fill of the priority order for the priority leg, wherein the confirmation identifies a priority price for the fill of the priority leg;
calculate, in response to receipt of the confirmation, a first price for a first order to buy or sell the first leg of the trading strategy, wherein the first price is calculated based on market conditions in the second tradeable object associated with the second leg, the received priority price, and the desired strategy price; and
communicate the first order to buy or sell the first leg of the trading strategy at the calculated first price to the electronic exchange.

10. The system of claim 9, wherein the processor is configured to:
receive a second confirmation of a fill of a second order for a fourth leg of the trading strategy, wherein the fourth leg is associated with the third tradeable object; and
classify the fourth leg as the priority leg based on the confirmation of the fill of the second order.

11. The system of claim 9, wherein the processor is configured to:
monitor the trading strategy;
identify the priority leg associated with the trading strategy; and
upon the identification of the priority leg, automatically refrain from filling a remainder of the at least three legs until receipt of the confirmation of the fill of the priority order for the priority leg.

12. The system of claim 11, wherein the priority leg is identified based on one or more of a quantity of the order for the priority leg, a price for the order of the priority leg, a liquidity of the priority leg, a duration of time for which the priority leg is at the electronic exchange, or a condition at the electronic exchange.

13. The system of claim 9, wherein the processor communicates, upon the filling of the first order to buy or sell the first leg at the first price, a trade action to the electronic exchange to fill a second order for the second leg.

14. The system of claim 9, wherein if the trading strategy is cancelled prior to receiving the confirmation of the fill of the priority order for the priority leg, the processor is configured to:
disassociate the at least three legs of the trading strategy; and
remove an identification of the priority leg; and
work the at least three legs at the electronic exchange to fill orders for the at least three legs.

15. A tangible computer readable storage medium comprising instructions that, when executed, cause a machine to at least:
receive a desired strategy price and a definition for a trading strategy including at least three legs, wherein the at least three legs include a first leg associated with a first tradeable object, a second leg associated with a second tradeable object, and a priority leg associated with a third tradeable object;
communicate a priority order for the priority leg to an electronic exchange;
receive a confirmation of a fill of the priority order for the priority leg, wherein the confirmation identifies a priority price for the fill of the priority leg;
calculate, in response to receipt of the confirmation, a first price for a first order to buy or sell the first leg of the trading strategy, wherein the first price is calculated based on market conditions in the second tradeable object associated with the second leg, the received priority price, and the desired strategy price; and
communicate the first order to buy or sell the first leg of the trading strategy at the calculated first price to the electronic exchange.

16. The tangible computer readable storage medium of claim 15, wherein the instructions cause the machine to:
receive a second confirmation of a fill of a second order for a fourth leg of the trading strategy, wherein the fourth leg is associated with the third tradeable object; and
identify the fourth leg as the priority leg based on the confirmation of the fill of the second order.

17. The tangible computer readable storage medium of claim 15, wherein the instructions cause the machine to:
monitor the trading strategy;
identify the priority leg associated with the trading strategy; and
upon the identification of the priority leg, automatically refrain from filling a remainder of the at least three legs until receipt of the confirmation of the fill of the priority order for the priority leg.

18. The tangible computer readable storage medium of claim 17, wherein the priority leg is identified based on one or more of a quantity of the order for the priority leg, a price for the order of the priority leg, a liquidity of the priority leg, a duration of time for which the priority leg is at the electronic exchange, or a condition at the electronic exchange.

19. The tangible computer readable storage medium of claim 15, wherein the instructions cause the machine to communicate, upon the filling of the first order to buy or sell the first leg at the first price, a trade action to the electronic exchange to fill a second order for the second leg.

20. The tangible computer readable storage medium of claim 15, wherein if the trading strategy is cancelled prior to receiving the confirmation of the fill of the priority order for the priority leg, the instructions cause the machine to:
disassociate the at least three legs of the trading strategy; and
remove an identification of the priority leg; and
work the at least three legs at the electronic exchange to fill orders for the at least three legs.
